(19) United States
(12) Patent Application Publication
(10) Pub. No.: US 2008/0133977 A1
(43) Pub. Date: Jun. 5, 2008

(54) NON-STOP DEBUGGING APPARATUS FOR CORRECTING ERRORS IN EMBEDDED SYSTEMS AND METHOD THEREOF

(75) Inventors: In Geol Chun, Seoul (KR); Choon Oh Lee, Daejeon (KR); Duk Kyun Woo, Daejeon (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Electronics and Telecommunications Research Institute, Daejeon (KR)

(21) Appl. No.: 11/941,039

(22) Filed: Nov. 15, 2007

(30) Foreign Application Priority Data
May 12, 2006 (KR) 10-2006-122337
Jun. 7, 2007 (KR) 10-2007-67987

(51) Int. Cl. G06F 11/00

(52) U.S. Cl. 714/38; 714/E11.001

(57) ABSTRACT

A debugging apparatus and method for correcting errors in embedded systems are provided. More particularly, a non-stop debugging apparatus and method for correcting errors in embedded systems in a development environment configured of a host and a target are provided.

With the non-stop debugging apparatus and method, application programs of the embedded systems can be easily debugged without the user having to frequently execute operation and stoppage of the application programs, in time-sensitive application programs and the application programs on which it takes a user much time to perform.

Also, according to the non-stop debugging apparatus and method, commands for the non-stop debugging and information required for other debugging are stored in the host system, thus making it possible to minimize the load of the target system so as to conform to the characteristics of the embedded systems sensitive to resource limitations.

### CROSS-REFERENCE TO RELATED APPLICATION

This application claims priority to and the benefit of Korean Patent Application No. 2006-0122337, filed Dec. 5, 2006, and No. 2007-0067987, filed Jul. 6, 2007, the disclosure of which is incorporated herein by reference in its entirety.

### BACKGROUND

1. Field of the Invention

The present invention relates to a debugging apparatus and method for correcting errors in embedded systems, and more specifically, to a non-stop debugging apparatus and method capable of detecting errors in embedded systems and debugging the errors without stopping the embedded systems, in a remote development environment configured of a host and a target.

The present invention is derived from research performed as a part of terminal adaptation embedded operating system technical development for mobile convergence computing for the Ministry of Information and Communication (South Korea) [Project Number: 2006-S-038-01, Project Title: Terminal Adaptation Embedded OS Platform Research].

2. Discussion of Related Art

As is generally known, unlike a general computer system, an embedded system is designed to perform a certain response or process with regard to inputs from users or from an external source. In other words, the functions logically defined within the system should be accurately performed according to a predetermined order and, in the case of the embedded system that is run in real time, these functions should be accurately performed within a predetermined time.

Such embedded systems have been developed in different ways from general application software. As a result, since there is a demand for substantial knowledge about the hardware of the embedded systems in addition to the software, it is very difficult to develop a reliable system. Therefore, in order to stably develop the embedded systems having such a high degree of developmental difficulty, a need exists for a method and apparatus for effectively detecting functional errors and correcting them so that they can reflect various demands, and thus be suitable for the characteristics of the embedded systems.

Meanwhile, since it is impossible to directly debug the embedded systems in the target due to the characteristics of the embedded systems, the debugging of the embedded systems may be performed in a remote debugging environment configured of a host and a target. Therefore, a method capable of performing the debugging while installing and executing a test program in the target, and an environment outputting and recording the information for the debugging and analyzing it in real time during the operation of the test program, such as a hardware debugging, have generally been provided separately.

Typically, in a case where software developers intend to perform debugging in a remote development environment, they may use a very simple method that inserts and executes a “printf” command into a point intending to record the information or, as a more advanced method, a method that tracks a program execution state generated in real time using a resource monitor.

However, the method inserting the printf command or codes for monitoring has the following problems: since the codes must be directly inserted into source codes and then executed, the integrity of the source codes can be degraded; it is troublesome to prepare and execute the test program by manually changing the source codes by numbers corresponding to a total number of cases to be tested; and, in particular, in the case of the embedded systems where an environment capable of outputting the results is not built, it is difficult to use the method.

In correcting the errors in the embedded system as described above, since it is troublesome to prepare and execute the test program and it is impossible to detect the errors using the test program, a strong need exists for technology that can detect the errors in the program in real time.

### SUMMARY OF THE INVENTION

The present invention is directed to a non-stop debugging apparatus and method capable of detecting and correcting errors generated when developing software for embedded systems, without stopping the system.

One aspect of the present invention provides a non-stop debugging apparatus for correcting errors in embedded systems, comprising: a host system including a user interface responsible for interfacing with a user, and a debugging engine that, when non-stop debugging-related instructions are input from the user through the user interface, provides information required for the debugging to a target system, and when receiving non-stop debugging processing results for application programs of the target system, displays the results to the user through the user interface; and a target system including a debugger stub that performs a non-stop debugging with reference to the information required for the debugging stored in the debugging engine, and provides the non-stop debugging processing results to the debugging engine of the host system.

Another aspect of the present invention provides a non-stop debugging method for correcting errors in embedded systems in a remote development environment configured of a host system and a target system, comprising the steps of: (a) receiving, at a host system, non-stop debugging instructions from a user; (b) interpreting, at the host system, the received instructions and converting them into commands used in application programs of a target system; (c) setting, at the host system, a non-stop debugging of the application programs; (d) performing, at the target system, the non-stop debugging set in the host system; (e) providing, at the target system, the non-stop debugging results to the host system; and (f) replaying the non-stop debugging results.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 is a functional block diagram showing a configuration of a non-stop debugging apparatus for correcting errors in embedded systems according to an exemplary embodiment of the present invention;

FIG. 2 is a functional block diagram showing a detailed configuration of a debugging engine installed in a host system in the non-stop debugging apparatus for correcting errors in the embedded systems of FIG. 1;

FIG. 3 is a functional block diagram showing a detailed configuration of a debugger stub installed in a target system in the non-stop debugging apparatus for correcting errors in the embedded systems of FIG. 1; and

FIG. 4 is a flowchart of a non-stop debugging method for correcting errors in the embedded systems according to the exemplary embodiment of the present invention.

### DETAILED DESCRIPTION OF EXEMPLARY EMBODIMENTS

Hereinafter, a non-stop debugging apparatus and method for correcting errors in embedded systems according to an exemplary embodiment of the present invention will be described in detail with reference to the accompanying drawings.

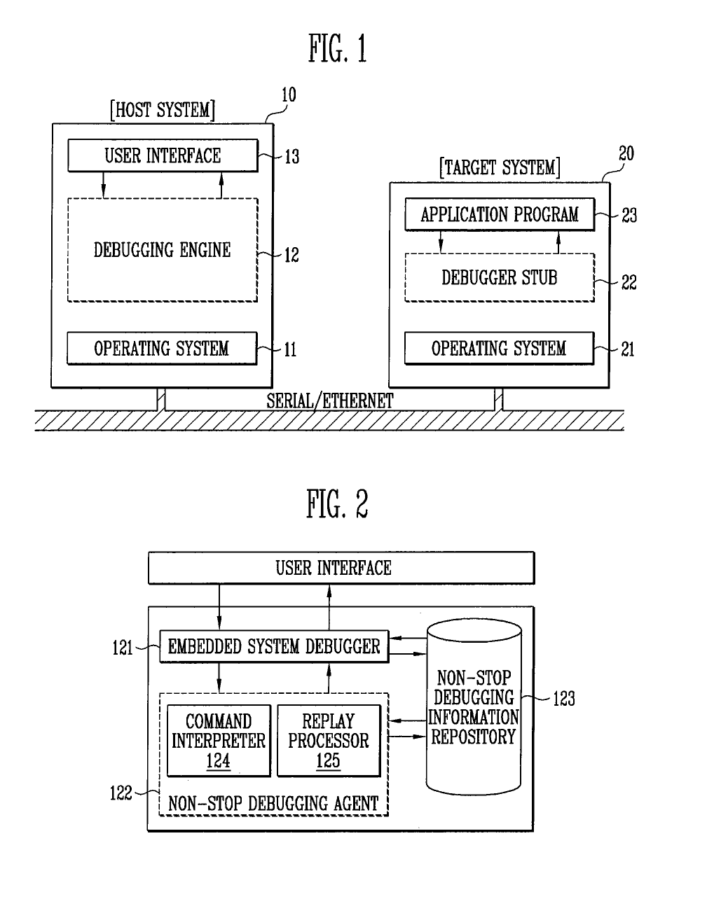

FIG. 1 is a functional block diagram showing a configuration of a non-stop debugging apparatus for correcting errors in embedded systems according to an exemplary embodiment of the present invention.

As shown in FIG. 1, since it is impossible to directly debug the embedded systems in the target due to the characteristics of the embedded systems, a debugging environment provided in the present invention is configured of a host system 10 and a target system 20, and the communication between both systems is made through the connection such as a serial or an Ethernet.

The host system 10 is configured in an operating system 11 that a developer wants to use, and is configured of a debugging engine 12 including a non-stop debugging agent (not shown) and a user interface 13 receiving instructions from a user and displaying the results. The target system 20 is configured by adding a debugger stub 22 in an operating system 21 used for actual development. An example of application programs 23 intending to detect and correct actual errors in such actual development is shown in FIG. 1.

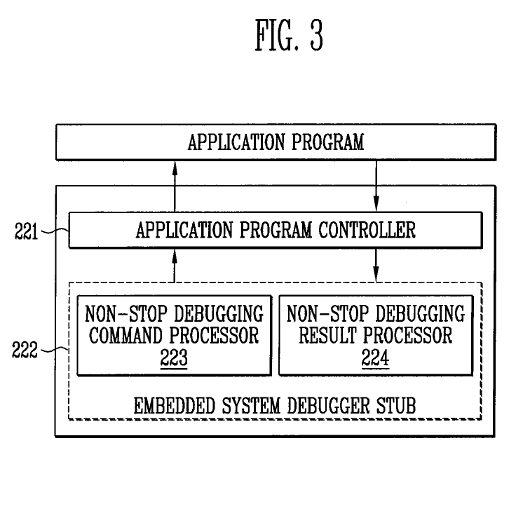

FIG. 2 shows a detailed configuration of the debugging engine 12 installed in the host system 10 in the non-stop debugging apparatus for correcting errors in the embedded systems according to the present invention.

Referring to FIG. 2, the user interface 13 is a graphic user interface (GUI) for receiving instructions from the user and displaying the results, and the debugging engine 12 includes: a general embedded system debugger 121; a non-stop debugging agent 122 responsible for the control for the non-stop debugging; and a non-stop debugging information repository 123 for storing a variety of information for the non-stop debugging, for example, a list of non-stop points, operations defined for each non-stop point to be performed at the points, dump values for the results, etc.

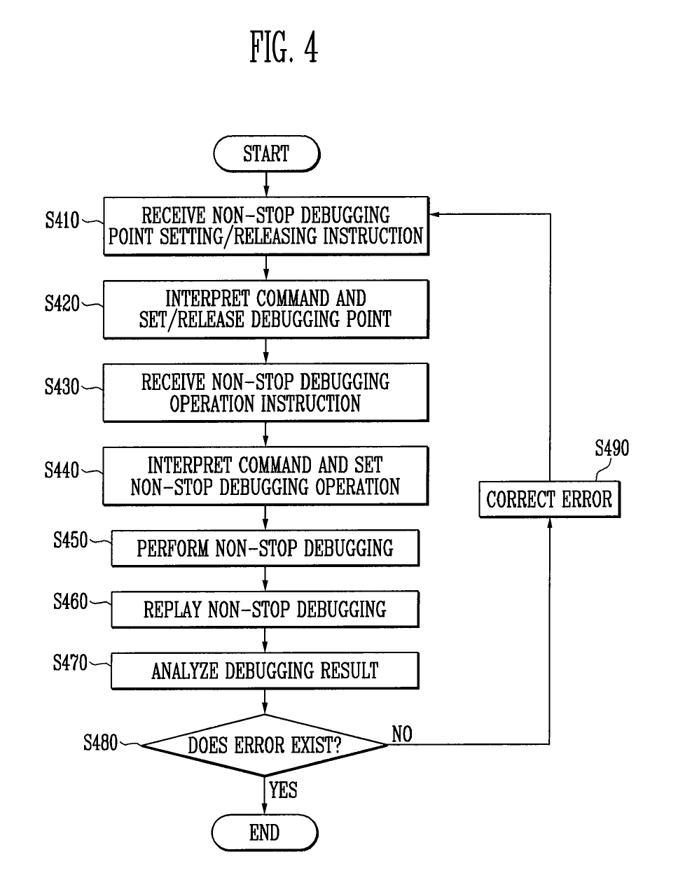

In particular, the non-stop debugging agent 122 includes a command interpreter 124 interpreting predetermined commands for non-stop debugging received through the user interface 13, e.g., commands setting and deleting the non-stop points and commands describing the operations to be performed at the non-stop points, with languages used in the application programs, and a replay processor 125 receiving and replaying the results of the non-stop debugging from a non-stop debugging result processor (see reference numeral 224 of FIG. 3) and displaying the results to the user through the user interface 13.

FIG. 3 shows a detailed configuration of a debugger stub 22 installed in the target system 20 in the non-stop debugging apparatus for correcting errors in the embedded systems, according to the present invention.

Referring to FIG. 3, the debugger stub 22 includes: an application program controller for controlling the application programs, wherein the application programs in which a developer intends to detect errors are controlled by means of an embedded system debugger stub 222 through the application program controller 221; a non-stop debugging command processor 223 for receiving non-stop debugging instructions sent from the debugging engine 12 of the host system and processing the debugging instructions with reference to the non-stop debugging information repository 123; a non-stop debugging result processor 224 for processing the non-stop debugging results to send them to the host system 10; and the embedded system debugger stub 222 for providing the debugging function in the general embedded system.

Next, FIG. 4 is a flow chart of a non-stop debugging method for correcting errors in the embedded systems according to an exemplary embodiment of the present invention.

Hereinafter, the debugging method for correcting errors in the embedded systems according to the present invention will be described with reference to FIGS. 2 to 4.

First, in step S410, a host system 10 is connected to application programs 23, which are a target of the error-correction, and receives non-stop debugging point setting and releasing instructions from a developer or a tester (hereinafter, referred to as “a user”) through a user interface 13.

In step S420, the instructions received from the user are interpreted by means of a command interpreter 124 of a debugging engine 12 and are converted into commands of a form used in the application programs. In the case of receiving the commands that set the non-stop debugging points from the user, the non-stop debugging points are set in a format recording the line numbers of the application programs in the target system to be debugged without being stopped in the non-stop debugging information repository 123. In the case of receiving the commands that release the non-stop debugging points, the non-stop debugging points are released in a format deleting the information of the corresponding lines from the non-stop debugging information repository 123.

Next, in step S430, the non-stop debugging operation instructions are received through the user interface 13 from the user. This is a step of setting the operations that the user wants to perform at the points set for the non-stop debugging in step S420, in particular, setting the operations recording the information that the user wants to receive at the points set for the non-stop debugging, etc., for example, predetermined information such as a state of the target system.

In step S440, the debugging agent 122 interprets the non-stop debugging operation instructions received from the user as described above through the command interpreter 124, and stores corresponding operation contents at the set debugging point in the non-stop debugging information repository 123.

Next, in step S450, the non-stop debugging point setting and the non-stop debugging operations defined through steps S420 and S440 are actually performed. In this step, based on the contents stored in the non-stop debugging information repository 123 of the host system 10, the embedded system debugger 121 cooperates with the non-stop debugging agent 122 to control the non-stop debugging stub 222 of the target system 20. At this time, in the target system 20, the non-stop debugging command processor 223 of the embedded system debugging stub 222 actually performs the non-stop debugging point setting and the non-stop debugging operations through the application program controller 221 based on the information stored in the non-stop debugging information repository 123 of the host system 10, and the non-stop debugging result processor 224 sends the dump values for the results, etc. to the embedded system debugger 121 of the host system 10 to storage them in the non-stop debugging information repository 123.

In step S460, after the non-stop debugging operations performed in step S450 are completed, the replay processor 125 replays the debugging dump files of the application programs 23 based on the information recorded in the non-stop debugging information repository 123. In this step, through the user interface 13, the user can see the results of performing the operations defined in step S440 at the point set in step S420. In particular, the user can obtain an effect similar to performing the debugging in real time through this replay.

In step S470, the debugging dump files of the replayed application programs 23 are confirmed and the debugging results are analyzed. The user compares the debugging results confirmed through the user interface 13 of the host system 10 with the results that he/she wants, or analyzes the debugging results to analyze the application programs' results. Finally, in step S480, if it is determined that the application programs have integrity, the debugging is ended, and if it is determined that the application programs have errors, the user corrects the errors in step S490 and then, steps S140 to S470 are repeated until the errors are no longer detected.

Using the non-stop debugging method according to the present invention, the user can ultimately obtain full error-correction of the application programs.

With the present invention, a user can detect and correct errors in application programs in a remote target system by means of a debugging engine in a host system. In particular, it can record the information of the application programs at a desired point in time, without the user having to frequently execute operation and stoppage of the application programs in the case of the time-sensitive application programs and the application programs in which it takes the user much time to perform, and can detect the errors in the application programs through a replaying function after the operation of all the application programs is completed. In contrast to a conventional debugging method, in the present invention, the debugging engine in the host stores commands and information for a non-stop debugging, and the target system has only a function to receive and process these commands and information and send the results. Therefore, it is possible to minimize the load on the target system, thus making the debugging engine of the present invention suitable for the characteristics of embedded systems that may be sensitive to resource limitations.

Also, a GUI is provided for user convenience so that developers can detect errors and easily correct the errors, in a state where the application programs of the embedded systems are not stopped, without purchasing special hardware.

Although the present invention has been described in detail with reference to an exemplary embodiment, the present invention is not limited to the exemplary embodiments and various modifications thereof, and can be implemented in a variety of ways without departing from the spirit and scope of the present invention.

What is claimed is:

1. A non-stop debugging apparatus for correcting errors in embedded systems, comprising:
a host system including a user interface responsible for interfacing with a user, and a debugging engine that, when non-stop debugging-related instructions are input from the user through the user interface, provides information required for the debugging to a target system, and when receiving non-stop debugging processing results for application programs of the target system, displays the results to the user through the user interface; and
a target system including a debugger stub that performs a non-stop debugging with reference to the information required for the debugging stored in the debugging engine, and provides the non-stop debugging processing results to the debugging engine of the host system.

2. The non-stop debugging apparatus of claim 1, wherein the non-stop debugging-related instruction comprises:
an instruction for setting or releasing a non-stop debugging point; and
an operation instruction at the non-stop debugging point that is set or released.

3. The non-stop debugging apparatus of claim 1, wherein the debugging engine comprises:
an embedded system debugger for receiving the non-stop debugging-related instructions from the user through the user interface and controlling the debugger stub of the target system;
a non-stop debugging information repository for storing the information required for the non-stop debugging and the debugging results provided from the target system; and
a non-stop debugging agent for communicating with the embedded system debugger and the non-stop debugging information repository, providing the information required for the non-stop debugging to the debugger stub, and receiving and replaying the debugging results.

4. The non-stop debugging apparatus of claim 3, wherein the non-stop debugging agent comprises:
a command interpreter for interpreting the non-stop debugging instructions received through the user interface and converting them into commands used in the application programs; and
a replay processor for replaying the debugging results stored in the non-stop debugging information repository.

5. The non-stop debugging apparatus of claim 3, wherein the debugger stub comprises:
an application program controller;
a non-stop debugging command processor for receiving the information stored in the debugging engine and performing the debugging instructions from the user by controlling the application programs through the application program controller; and
a non-stop debugging result processor for providing the results of the debugging instructions to the non-stop debugging agent of the host system.

6. The non-stop debugging apparatus of claim 4, wherein the non-stop debugging agent stores the results of the debugging instructions in the non-stop debugging information repository.

7. The non-stop debugging apparatus of claim 5, wherein the host system and the target system are connected to and communicate with each other by means of a serial or an Ethernet, and the user interface is a graphic user interface (GUI).

8. A non-stop debugging method for correcting errors in embedded systems in a remote development environment configured of a host system and a target system, comprising the steps of:
(a) receiving, at a host system, non-stop debugging instructions from a user;
(b) interpreting, at the host system, the received instructions and converting them into commands used in application programs of a target system;
(c) setting, at the host system, a non-stop debugging of the application programs;
(d) performing, at the target system, the non-stop debugging set in the host system;
(e) providing, at the target system, the non-stop debugging results to the host system; and
(f) replaying the non-stop debugging results.

9. The method of claim 8, further comprising the steps of:
(g) analyzing the non-stop debugging results; and
(h) determining the integrity of the application programs.

10. The method of claim 8, wherein the non-stop debugging instructions received from the user in step (a) comprises:
an instruction for setting or releasing non-stop debugging points; and
an operation instruction at the non-stop debugging point that is set or released.

11. The method of claim 10, wherein the step of setting the non-stop debugging in step (c) is performed by storing the instructions converted into the commands used in the application programs and the related information in the host system.

12. The method of claim 11, wherein the step of performing the non-stop debugging in the target system in step (d) is performed with reference to the non-stop debugging instructions stored in the host system and the related information.
